(19) United States
(12) Patent Application Publication
(10) Pub. No.: US 2007/0122770 A1
(43) Pub. Date: May 31, 2007

(54) Dry fire training module and safe method for training with live conductive energy devices

(75) Inventor: Frederick B. Swensen, Sugar Land, TX (US)

Correspondence Address: LASER SHOT, INC., 12818 CENTURY DRIVE, STAFFORD, TX, 77477, US

(73) Assignee: PARFIPH, INC

(21) Appl. No.: 11/272,410

(22) Filed: Nov. 10, 2005

(51) Int. Cl. F41G 3/26; G09B 19/00

(52) U.S. Cl. 434/16

(57) ABSTRACT

A dry-fire training module for conductive energy devices and a method to determine the approximate trajectories of darts fired by live modules. The dry-fire training module snaps into the front of a live conductive energy device. The dry-fire training module is reversible to the conductive energy device. The conductive energy device can be fired with the dry-fire training module in place. A high voltage conductor eliminates the high voltage potential across the front of the conductive energy device. When the conductive energy device is fired, the sensor in the dry-fire training module detects the high energy pulse of the discharge and triggers two lasers within the module to emit beams of differing frequencies. The lasers are fired for a duration sufficient to be detected by a target sensor. The striking points of the laser beams against the target surface demonstrate the approximate striking points of the darts fired by live modules.

### CROSS-REFERENCE TO RELATED APPLICATIONS

Not applicable.

### STATEMENT REGARDING FEDERALLY SPONSORED R & D

Not applicable.

### REFERENCE TO A MICROFICHE APPENDIX

Not applicable.

### BACKGROUND OF THE INVENTION

The present invention relates generally to conductive energy devices. More particularly, this invention relates to a dry-fire training module that can be used with conductive energy devices, and a safe method for training with live conductive energy devices.

Today's law enforcement and military personnel have an array of weapons suited to their enforcement tasks. While the force option is always available, the use of force should follow a force continuum. This force continuum should allow for a progression of force that can be justified as necessary and reasonable depending upon the situation. However, there are instances where lethal weapons and countermeasures are inappropriate, and the use of which may be unlawful. Law enforcement, military and security personnel have come to increasingly rely on non-lethal threat deterrence systems to immobilize and disable targets and, in general, neutralize threats without causing permanent injury to the target being suppressed. Conductive energy devices (CED), tear gas and pepper spray, have been proven to reduce the likelihood of injuries to innocent bystanders, the target and to the law enforcement personnel themselves.

U.S. Pat. No. 3,803,463 to John H. Cover teaches a weapon, used to subdue and restrain targets, that includes a harmless projectile connected by means of conductive wire to a launcher that contains an electrical power supply. This invention has been marketed as the TASER®, a trademark for weapons for immobilization and capture. TASER devices lead the CED market segment. TASER devices can incapacitate targets nearly instantaneously. Therefore, they have been successfully employed in hostage situations, to thwart suicides, to arrest potential terrorists and in many other high risk situations.

A typical TASER device works on ordinary batteries. The batteries supply electricity to a circuit consisting of various electrical components. The circuitry includes multiple transformers that boost voltage and reduce amperage. It also includes an oscillator that produces specific pulse patterns of electricity. This current charges a capacitor. The capacitor builds up a charge and releases it to two electrodes, an upper electrode and a lower electrode. When the trigger is pulled, a compressed gas cartridge inside the device ruptures. The expanding gas builds pressure behind the charge electrodes. This launches two darts, an upper dart and a lower dart, from the TASER cartridges or modules used with the TASER device, with conductive wires trailing behind the darts. The darts are affixed with small barbs to latch on to a target's clothing. Once the darts are attached, current travels down the wires into the target's body. A live TASER cartridge can only be used once. TASER devices produce a spark and a crackling sound when they are triggered. TASER devices are not classified as firearms since they use compressed nitrogen as the propellant.

TASER devices function by causing electromuscular disruption (EMD). EMD weapons directly control the skeletal muscles. The electrical signals of the TASER mimic signals used by the human brain to communicate with the body. The TASER signals overpower the normal electrical signals within the body's nerve fibers. The EMD effect causes an uncontrollable contraction of the skeletal muscles, which results in physical debilitation of the target. However, since it is not the voltage that determines the effect of electricity on the body but rather the amperage, TASER signals do not affect the heart or other vital organs. TASER devices are not dependent on the target's pain threshold or mental focus. Hence, they can even be effective for dealing with individuals who may be non-responsive to pain due to drugs, alcohol or mental illness.

TASER devices have recently come under increased scrutiny in light of reported deaths that have been supposedly associated with their use. Nevertheless, current scientific and medical studies have failed to conclusively link any of these deaths to the use of TASER devices. In fact, current research indicates that when used according to appropriate guidelines by trained personnel, TASER devices generally present a low risk of danger to the target.

Gaining proficiency in the use of TASER devices requires extensive training and practice. Judgmental training, that is, evaluating when using the force option is appropriate, is also extremely critical. It would be extremely beneficial to train with live TASER devices. However, live TASER devices require careful handling and may be inappropriate to use as training devices. TASER devices are also expensive; novice users may end up depleting and wasting expensive TASER cartridges or modules, since these modules can be only used once. There is also a high voltage hazard because of the high voltage discharge present across the TASER device's upper and lower electrodes. There is also the potential of injury from a secondary fall after being shot by a TASER device. This has apparently deterred some officers from using TASER devices on each other during training. Currently, training is conducted using “blue” TASER guns and/or “blue modules.” The “blue” guns are non-functional, blue colored TASER devices that have laser modules in place of the live modules. However, these devices are non-functional and are not completely satisfactory from a training perspective. The look, feel and sound of these devices is different from live TASER devices. Also, purchasing these devices adds to the overall training expense. The “blue modules” are “blue” colored modules that snap on to a live TASER device. When triggered, these blue modules emit darts that are connected with plastic lines instead of the conductive wires of a live module. However, the blue modules do not eliminate the high voltage hazard present across the upper and lower electrodes of the TASER device. The blue modules can be used only once and these modules are as expensive as the live modules. Another problem with the use of the blue module is that the sound emitted, when the TASER device is triggered with the blue module, differs significantly from that emitted by a TASER device with a live module. Therefore, there exists a market for a TASER training device that has the same shape, weight, balance, feel and sound of a live device; is inexpensive; and can be used without any of the risks inherent in a live TASER device. While the prior art discloses dry-fire training firearms, a discussion of that is beyond the scope of the present invention which specifically pertains to a dry-fire training module and methodology for CED. The present invention is an apparatus that consists of a dry-fire module that allows use of live TASER devices for training and practice. The invention can be used with unmodified, live TASER devices; this negates the need and renders unnecessary the expenses associated with procuring a separate TASER training device.

### BRIEF SUMMARY OF THE INVENTION

The invention is an apparatus that consists of a dry fire module that allows use of live TASER devices for training and practice. The dry-fire module has the same outer dimensions and approximate weight of a live TASER module. The module contains two lasers, a sensor, a high-voltage conductor, a signal conditioner, a pulse control circuit, a battery and a reset mechanism. The dry-fire module is detachable. It is reversible and it can be snapped into the front of the TASER device, similar to a live module, without regard to polarity. The two lasers are aligned to simulate the trajectories of the upper and lower darts of the live TASER device. The dry-fire module does not interfere with normal operation of the TASER device.

The dry-fire module is a training aid designed to allow dry-fire training on an unmodified live TASER device. The dry-fire module may be operated from a live TASER device. The dry-fire module maintains the external dimensions of a live module, including the placement of the electrodes. The dry-fire module can be holstered or carried in the same manner as a live TASER module.

When the TASER device is fired, the sensor in the dry-fire module detects the high energy pulse of the TASER discharge. This triggers the lasers to fire two laser beams that simulate the approximate dart trajectory of a live TASER. The signal from the sensor is conditioned to fire the lasers for the desired pulse duration. A pulse control circuit stops repeated firing of the laser, providing a single laser pulse for each laser. This corresponds to the functioning of a single use live TASER module. Each laser can be uniquely modulated or coded for differentiation by the target sensor. The laser strikes may be visible for visual training or pulsed for hit detection by all major brands of laser target receivers. The sound emitted by the dry-fire module upon discharge emulates that of the live TASER when fired. The dry-fire module must be reset prior to re-firing. Resetting the dry-fire module is performed either manually or with an automatic time delay reset. The striking points of the laser beams against any reflective surface demonstrate the approximate striking points of the darts. These features aid trainers in demonstrating the approximate trajectory of the darts without the use of high-speed darts.

### OBJECTIVES OF THE INVENTION

During the development of the dry-fire module, the primary objective was to ensure replication of the physical characteristics of a live module. This has been achieved by developing the dry-fire module around an empty TASER module. This ensures that the dry-fire module will fit into the live TASER device. Another objective was to achieve complete compatibility with an unmodified TASER device. And, the final objective was to replicate the functional characteristics, including portability, single use, sound, safety and reversibility of a live module.

### Safety Features

The dry-fire module provides for a safer means of training by eliminating the darts and shorting the high voltage present across a live TASER device, even with a spent cartridge. The lasers replace the darts and thus, provide a safer training alternative. When installed in the front of the TASER device, the high-voltage conductor of the dry-fire module shorts the high voltage that is present across the electrodes of a live TASER. This eliminates the high voltage hazard when training with a live TASER device.

### BRIEF DESCRIPTION OF THE SEVERAL VIEWS OF THE DRAWING

FIG. 1 shows the invention, a dry-fire module, in an example training application. The invention (1) is inserted into a live TASER device (2). The trajectory of the upper dart of a live TASER module is simulated by an upper laser beam (3) and the trajectory of the lower dart of a live TASER module is simulated by a lower laser beam (4) onto the target (5). The target (5) can be any type of laser receiver including, but not limited to, a camera, an electronic sensor, or a reflective surface.

FIG. 2a, FIG. 2b and FIG. 2c show the outer case of the invention (1) and connection to the TASER (2). FIG. 2a shows the invention (1) inserted into the front of the TASER (2). The TASER device's (2) upper electrode (6) aligns with the invention's upper electrode (8) and the TASER device's (2) lower electrode (7) aligns with the invention's lower electrode (9).

FIG. 2b shows the front view of the invention (1). The upper laser (13) is aimed from the front of the dry-fire module (1) in alignment to simulate the trajectory of the upper dart (3). The lower laser (14) is aimed from the front of the invention (1) in alignment to simulate the trajectory of the lower dart (4).

FIG. 2c shows the back view of the invention (1) and the location of the invention's upper electrode (8) and lower electrode (9).

FIG. 3 shows a functional diagram of the invention. The high-voltage conductor (18) is connected to the upper electrode (8) and the lower electrode (9). The sensor (10) is connected to the high-voltage conductor (18). The sensor (10) detects the high voltage, potential across the high-voltage conductor (18) and transfers this signal to the signal conditioner (11). The signal conditioner (11) converts the incoming signal from the sensor (10) to a usable level for the pulse control (12). The pulse control (12) regulates the length of the pulse sent to fire the upper laser (13), the lower laser (14), Frequency 1 Modulator or Encoder (15), and Frequency 2 Modulator or Encoder (16). The upper laser's (13) pulse can be modulated or encoded by the frequency modulator/encoder (15) and the lower laser's (14) pulse can be modulated or encoded by the frequency modulator or encoder (16) as required by the target receiver. The pulse control (12) allows only one pulse for the upper laser (13) and one pulse for the lower laser (14) before requiring to be reset. The pulse control (12) is reset by an automatic or manual reset (17). The battery (19) provides power directly to the sensor (10), signal conditioner (11) and pulse control (12). The upper laser (13), lower laser (114), Frequency 1 Modulator or Encoder (15), and Frequency 2 Modulator or Encoder (16) receive power from the battery (19) through the pulse control (12).

### DETAILED DESCRIPTION OF THE INVENTION

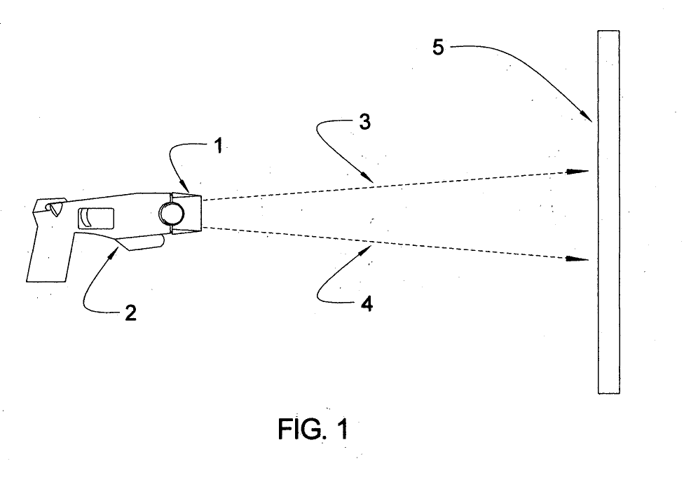

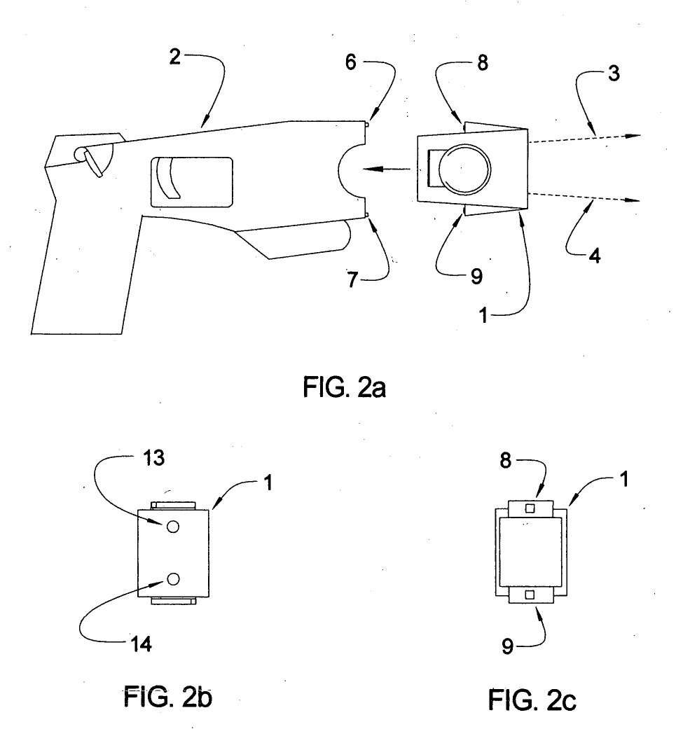

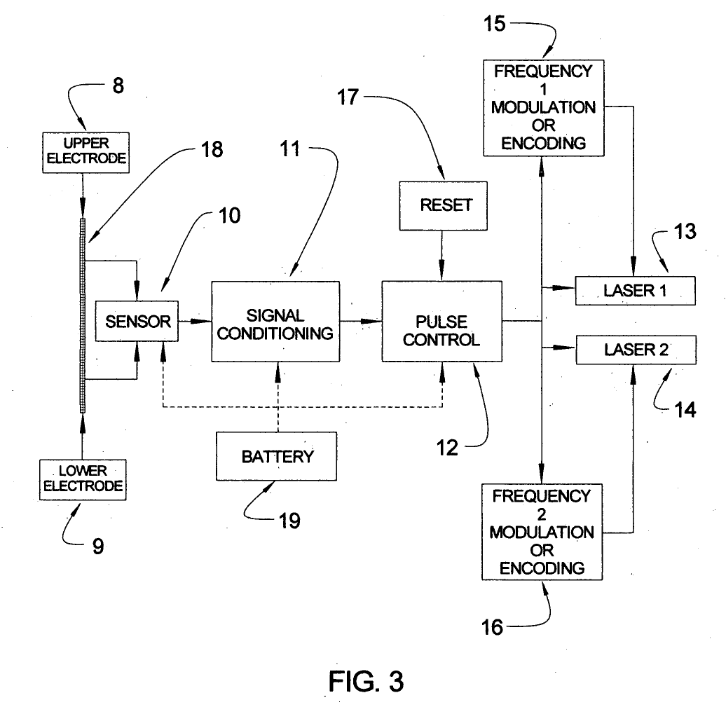

The present invention provides an economical and safe method for training with a live TASER device (2) by providing dry-fire training and practice. The invention (1) is demonstrated in FIG. 1. The invention, a dry-fire module, (1) replaces a live module capable of firing two darts connected with wires and inducing a high voltage electrical charge, with an upper laser (13) that simulates the trajectory of the upper dart (3) and a lower laser (14) that simulates the trajectory of the lower dart (4). The laser beams can be detected by a reflective device or any of several receivers, including but not limited to, cameras, electronic sensors or reflective surface.

The invention (1) attaches to the TASER device (2) in the same manner as a live module. The external properties of the invention (1) are similar to a live module to provide for a realistic training experience. The invention (1) is activated by the high voltage discharge of the TASER device (2). The high voltage potential of the TASER device is across the TASER device's upper electrode (6) and its lower electrode (7). When the invention (1) is inserted into the front of the TASER device (2) the upper electrode (6) of the TASER (2) aligns with the upper electrode (8) of the invention (1) and the lower electrode (7) of the TASER (2) aligns with the lower electrode (9) of the invention (1). When the invention (1) is inserted into the front of the TASER (2), the high-voltage conductor (18), which is connected to the upper electrode (8) and the lower electrode (9) of the invention (1), provides a direct conductive path between the upper electrode (8) and the lower electrode (9) of the invention (1). This eliminates the high voltage discharge present across the upper electrode (6) and the lower electrode (7) when the TASER (2) is discharged. This acts as a safety feature by reducing the high voltage shock hazard present when handling a live TASER device (2) during training or practice. The invention (1) can also be inserted into the TASER (2) with the upper electrode (8) and the lower electrode (9) reversed with respect to the TASER device's (2) upper electrode (6) and lower electrode (7).

The sensor (10) is connected to the high-voltage conductor (18) and detects the high voltage potential across the high-voltage conductor (18). When the sensor (10) detects the high voltage discharge of the TASER (2), the output of the sensor is amplified and the duration is increased by the signal conditioner (11) to provide the proper, signal to the pulse control (12). The pulse control (12) regulates the length of the pulse sent to fire the upper laser (13), the lower laser (14), Frequency 1 Modulator or Encoder (15), and Frequency 2 Modulator or Encoder (16). The upper laser (13) and the lower laser (14) are positioned at a 3.5 degree angle from a virtual median. The upper laser's (13) pulse can be modulated or encoded by the frequency modulator/encoder (15) and the lower laser's (14) pulse can be modulated or encoded by the frequency modulator/encoder (16) as required by the target receiver. The use of different frequencies or encoding for the two lasers permits identifying the hit location of each laser. Each laser can be set to fire for a duration between 5 milliseconds to 5 seconds. The pulse control (12) also limits the firing of the upper laser (13) and lower laser (14) to one pulse each. In order for the pulse control (12) to allow the upper laser (13) and lower laser (14) to fire again, the reset (17) must signal the pulse control (12). The reset (17) can be set to manually reset the pulse control (12) or automatically reset the pulse control (12) after a set period of time. The limitation of only one pulse before resetting simulates the one use per live module of the TASER device (2). When the invention is snapped into the TASER device (2), there is an air gap between the upper electrode (6) of the TASER (2) and the upper electrode (8) of the invention (1) and the lower electrode (7) of the TASER (2) and the lower electrode (9) of the invention (1). When the TASER device (2) is fired, the electric charge traveling from the upper electrode (6) of the TASER (2) and the upper electrode (8) of the invention (1) and the lower electrode (7) of the TASER (2) and the lower electrode (9) of the invention (1), produces a spark and a crackling sound. The sound emitted from the invention (1) when fired is similar to that of a TASER (2) fired with a live module. The invention (1) can be triggered by detection of a light pulse from a spark, sound of arcing, electromagnetic pulse from discharge, or voltage divider.

While the illustrative embodiments and drawings have been described with particularity and the discussion has primarily focused on the TASER device, it should be appreciated that the invention may be utilized with any conductive energy device or stun gun model and various other modifications will be apparent to and can be readily made by those skilled in the art without departing from the spirit and scope of the invention. Accordingly, it is not intended that the scope of the claims appended hereto be limited to the examples and description set forth herein but rather that the claims be construed as encompassing all the features of patentable novelty which reside within the present invention, including all features which would be treated as equivalents thereof by those skilled in the art to which this invention pertains.

What is claimed is:

1. A dry-fire training module for conductive energy devices, said dry-fire training module comprising:
a rigid housing, substantially the same size, shape and weight as a live module for a conductive energy device, said housing having a front end and a back end;
an upper electrode at said back end of the housing;
a lower electrode facing said upper electrode at said back end of the housing;
a high-voltage conductor contained within said housing and connected to said upper electrode and lower electrode;
a sensor contained within said housing and connected to said high voltage conductor;
a signal conditioner contained within said housing and connected to said sensor;
a pulse control circuit contained within said housing and connected to said signal conditioner;
a reset mechanism contained within said housing and connected to said pulse control circuit;
two frequency modulators or encoders contained within said housing and connected to said pulse control circuit;
two sources of coherent electromagnetic radiation contained within said housing; and
a power supply contained within said housing and connected to said sensor, signal conditioner and pulse control circuit.

2. The dry-fire training module of claim 1, wherein said sources of coherent electromagnetic radiation are diode lasers.

3. The lasers of claim 2, wherein each laser is positioned at opposite ends at a 3.5 degree angle from a virtual median facing each other.

4. The lasers of claim 2, wherein each laser is connected to a frequency modulator or encoder.

5. The frequency modulators or encoders of claim 1, wherein each modulator or encoder is set to a different frequency or code for differentiation by detection devices or reflectors.

6. The dry-fire training module of claim 1, wherein said housing has two ports in said front end and wherein said sources of coherent electromagnetic radiation are oriented to shine said radiation through said ports.

7. The dry-fire training module of claim 1, wherein said power supply is a battery.

8. The dry-fire training module of claim 1, wherein said upper electrode of the dry-fire training module is aligned to the upper electrode of the conductive energy device and said lower electrode of the dry-fire training module is aligned to the lower electrode of the conductive energy device.

9. The dry-fire training module of claim 1, wherein said upper electrode of the dry-fire training module may also be aligned to the lower electrode of the conductive energy device and said lower electrode of the dry-fire training module may also be aligned to the upper electrode of the conductive energy device without regard to polarity.

10. The dry-fire training module of claim 1, wherein an air gap exists between said upper electrode of the dry-fire training module and upper electrode of the conductive energy device and said lower electrode of the dry-fire training module and lower electrode of the conductive energy device, when the dry-fire training module is snapped to the front of the conductive energy device.

11. A safe method for training using live conductive energy devices comprising the steps of:
snapping on a dry-fire training module containing a rigid housing to the front end of a conductive energy device;
triggering said conductive energy device to emit a high voltage discharge;
shorting said discharge using a high voltage conductor within said housing;
detecting said high voltage discharge using a sensor;
amplifying the output of said discharge from said sensor and altering the duration of the discharge using a signal conditioner;
converting said discharge from said signal conditioner to a single pulse and regulating the length of the pulse using a pulse control circuit;
using two frequency modulators or encoders each set to a unique frequency or code to differentiate each pulse from said pulse control circuit;
activating two diode lasers by said pulse to fire two beams of different frequencies or codes;
detection of said laser beams by a target detector or reflector.

12. The method of claim 11, wherein the triggering includes detection of a light pulse from a spark, sound of arcing, electromagnetic pulse from discharge, or voltage divider.

13. The method of claim 11, wherein said laser beams can be set to fire for a duration between 5 milliseconds and 5 seconds.

14. The method of claim 11, wherein said pulse control circuit must be reset after each pulse to allow said diode lasers to fire again.

15. The method of claim 13, wherein said pulse control circuit can be set to manually reset the pulse control or to automatically reset the pulse.

16. The method of claim 11, wherein said target detector or reflector is selected from the group consisting of cameras, electronic sensors or reflective panels.
